(19) United States
(12) Patent Application Publication
(10) Pub. No.: US 2005/0163263 A1
(43) Pub. Date: Jul. 28, 2005

(54) Systems and methods for frequency acquisition in a wireless communication network

(76) Inventors: Alok Kumar Gupta, San Diego, CA (US); Fuyun Ling, San Diego, CA (US)

Correspondence Address: Qualcomm Incorporated;Patents Department, 5775 Morehouse Drive, San Diego, CA, 92121-1714, US

(21) Appl. No.: 11/021,028

(22) Filed: Dec. 22, 2004

Related U.S. Application Data
(60) Provisional application No. 60/539,941, filed on Jan. 28, 2004.
(60) Provisional application No. 60/540,089, filed on Jan. 28, 2004.

(51) Int. Cl. H04L 27/06

(52) U.S. Cl. 375/343

(57) ABSTRACT

The disclosed embodiments provide for methods and systems for initial frequency acquisition in a wireless communication network. In one aspect, a method for initial frequency acquisition includes the acts of receiving a stream of input samples from a transmitter, determining an estimate for a frequency offset associated with the transmitter and the receiver based on the received input samples, and compensating for the frequency offset to achieve an initial frequency acquisition.

### CROSS REFERENCE TO RELATED APPLICATIONS

This application claims the benefit of U.S. Provisional Application Ser. No. 60/539,941 entitled “Method and Apparatus for Initial Frequency Acquisition in an OFDM Receiver in the Presence of Variable Gain VCXO,” filed on Jan. 28, 2004.

This application also claims priority to U.S. Application Ser. No. 60/540,089 entitled “Procedure to Acquire Frame Synchronization and Initial OFDM Symbol Timing from the Detection of TDM Pilot,” filed on Jan. 28, 2004. The entireties of the aforementioned applications are incorporated herein by reference.

### BACKGROUND

I. Field

The invention relates generally to communications and more particularly toward initial frequency acquisition and synchronization.

II. Background

There is an increasing demand for high capacity and reliable communication systems. Today, data traffic originates primarily from mobile telephones as well as desktop or portable computers. As time passes and technology evolves, it is foreseeable that there will be increased demand from other communication devices, some of which have not been developed as of yet. For example, devices not currently thought of as communication devices, such as appliances as well other consumer devices, will generate huge amounts of data for transmission. Furthermore, present day devices, such as mobile phones and personal digital assists (PDAs), among others, will not only be more prevalent but also demand unprecedented bandwidth to support large and complex interactive and multimedia applications.

While data traffic can be transmitted via wire, demand for wireless communication is currently and will continue to skyrocket. The increasing mobility of people of our society requires that technology associated therewith be portable as well. Thus, today many people utilize mobile phones and PDAs for voice and data transmission (e.g., mobile web, email, instant messaging . . . ). Additionally, growing numbers of people are constructing wireless home and office networks and further expecting wireless hotspots to enable Internet connectivity in schools, coffee houses, airports and other public places. Still further yet, there continues to be a large-scale movement toward integration of computer and communication technology in transportation vehicles such as cars, boats, planes, trains, etc. In essence, as computing and communication technologies continue to become more and more ubiquitous demand will continue to increase in the wireless realm in particular as it is often the most practical and convenient communication medium.

In general, the wireless communication process includes both a sender and a receiver. The sender modulates data on a carrier signal and subsequently transmits that carrier signal over a transmission medium (e.g., radio frequency). The receiver is then responsible for receiving the carrier signal over the transmission medium. More particularly, the receiver is tasked with synchronizing the received signal to determine the start of a signal, information contained by the signal, and whether or not the signal contains a message. However, synchronization is complicated by noise, interference and other factors. Despite such obstacles, the receiver must still detect or identify the signal and interpret the content to enable communication.

Communication systems are widely deployed to provide various communication services such as voice, packet data, and so on. These systems may be time, frequency, and/or code division multiple-access systems capable of supporting communication with multiple users simultaneously by sharing the available system resources.

Examples of such multiple-access systems include Code Division Multiple Access (CDMA) systems, Multiple-Carrier CDMA (MC-CDMA), Wideband CDMA (W-CDMA), High-Speed Downlink Packet Access (HSDPA), Time Division Multiple Access (TDMA) systems, Frequency Division Multiple Access (FDMA) systems, and Orthogonal Frequency Division Multiple Access (OFDMA) systems.

One of the modulation schemes rapidly gaining commercial acceptance is based on orthogonal frequency division multiplexing (OFDM). OFDM is a parallel transmission communication scheme where a high-rate data stream is split over a large number of lower-rate streams and transmitted simultaneously over multiple sub-carriers spaced apart at particular frequencies or tones. The precise spacing of frequencies provides orthogonality between tones. Orthogonal frequencies minimize or eliminate crosstalk or interference amongst communication signals. In addition to high transmission rates, and resistance to interference, high spectral efficiency can be obtained as frequencies can overlap without mutual interference.

However, OFDM systems may be sensitive to receiver synchronization errors. This can cause degradation of system performance. In particular, the system can lose orthogonality amongst subcarriers and thus network users. To preserve orthogonality, the transmitter and the receiver may be synchronized. In sum, receiver synchronization is paramount to successful OFDM communications.

Accordingly, there is a need for a novel system and method of expeditious and reliable initial frequency acquisition and synchronization for OFDM/OFDMA systems.

### SUMMARY

The disclosed embodiments provide for methods and systems for initial frequency acquisition in a wireless communication network. In one aspect, a method for initial frequency acquisition includes the acts of receiving a stream of input samples from a transmitter, determining an estimate for a frequency offset associated with the transmitter and the receiver based on the received input samples, and compensating for the frequency offset to achieve an initial frequency acquisition.

### BRIEF DESCRIPTION OF THE DRAWINGS

The foregoing and other aspects of the invention will become apparent from the following detailed description and the appended drawings described in brief hereinafter.

FIG. 1 is a block diagram of coarse frame detection system;

FIG. 2a is graph of a correlation curve in an ideal single path environment;

FIG. 2b is a graph of a correlation curve in a real multipath environment;

FIG. 3 is a block diagram of an embodiment of a confirmation component;

FIG. 4 is a block diagram of an embodiment of a trailing edge component;

FIG. 5 is a block diagram of an embodiment of a delayed correlator component;

FIG. 6 is a block diagram of an embodiment of a fine frame detection system;

FIG. 7 is a flow chart diagram of an initial coarse frame detection methodology;

FIG. 8 is a flow chart diagram of a leading edge detection methodology;

FIG. 9 is a flow chart diagram of a leading edge confirmation and flat zone detection methodology;

FIG. 10a is a flow chart diagram of a leading edge confirmation and flat zone detection methodology;

FIG. 10b is a flow chart diagram of a leading edge confirmation and flat zone detection methodology;

FIG. 11 is a flow chart diagram of a trailing edge detection methodology;

FIG. 12 is a flow chart diagram of a frame synchronization methodology;

FIG. 13 is a schematic block diagram of a suitable operating environment for implementing the disclosed embodiments;

FIG. 14 is a diagram of an embodiment of a super-frame structure for use in an OFDM system;

FIG. 15a is diagram of an embodiment of a TDM pilot-1;

FIG. 15b is diagram of an embodiment of a TDM pilot-2;

FIG. 16 is a block diagram of an embodiment of TX data and pilot processor at an access point;

FIG. 17 is a block diagram of an embodiment of OFDM modulator at an access point;

FIG. 18a is a diagram of a time-domain representation of TDM pilot-1;

FIG. 18b is a diagram of a time-domain representation of TDM pilot-2;

FIG. 19 is a block diagram of an embodiment of synchronization and channel estimation unit at a access terminal; and

FIG. 20 is a block diagram of a frequency locked-loop (FLL).

### DETAILED DESCRIPTION

The disclosed embodiments are now described with reference to the annexed drawings, wherein like numerals refer to like or corresponding elements throughout. It should be understood, however, that the drawings and detailed description thereto are not intended to limit the invention to the particular embodiments disclosed. Rather, the disclosed embodiments are to cover all modifications, equivalents, and alternatives falling within the spirit and scope of the claims.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer (e.g.. desktop, portable, mini, palm . . . ). By way of illustration, both an application running on a computer device and the device itself can be a component. One or more components may reside within a process and/or thread of execution and a component may be localized on one computer and/or distributed between two or more computers.

Furthermore, aspects of the disclosed embodiments may be implemented as a method, apparatus, or article of manufacture using standard programming and/or engineering techniques to produce software, firmware, hardware, or any combination thereof to control a computer to implement the disclosed methods. The term “article of manufacture” (or alternatively, “computer program product”) as used herein is intended to encompass a computer program accessible from any computer-readable device, carrier, or media. For example, computer readable media can include but is not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the disclosed embodiments.

The disclosed embodiments and the corresponding disclosure are described in connection with a subscriber station. A subscriber station can also be called a system, a subscriber unit, mobile station, mobile, remote station, access point, remote terminal, access terminal, user terminal, user agent, or user equipment. A subscriber station may be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem.

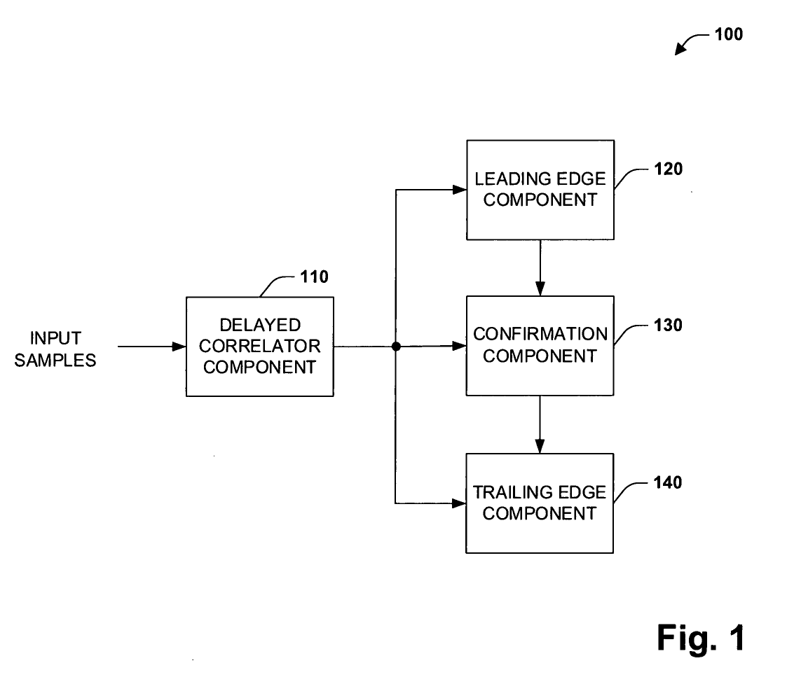

Turning initially to FIG. 1, frame detection system 100 is depicted. More specifically, system 100 is a receiver side sub-system associated with synchronization of OFDM transmissions. Synchronization refers generally to the process performed by a receiver to obtain both frame and symbol timing. As will be described in more detail in the sections that follow, frame detection is based on identification of pilot or training symbols transmitted at the start of a frame or super-frame. In one embodiment, the pilot symbols are time division multiplexed (TDM) pilots. In particular, a first pilot symbol can be employed for coarse estimate of frame and OFDM symbol boundary, inter alia, while a second pilot symbol can be utilized for to improve such estimate. System 100 is primarily concerned with detection of the first pilot symbol for frame detection, although it can be utilized in conjunction with the detection of other training symbols. System 100 includes delayed correlator component 110, leading edge detection component 120, confirmation component 130, and trailing edge detection component 130.

The delayed correlator component 110 receives a stream of digital input signals from an access terminal receiver (not shown). The delayed correlator component 110 processes the input signals and produces detection metrics or correlation outputs (Sₙ) associated therewith. A detection metric or correlation output is indicative of the energy associated with one pilot sequence. The computation mechanisms that generate detection metrics from steams of input signals will be presented in detail infra. Detection metrics are provided to a leading edge component 120, a confirmation component 130, and a trailing edge component 140 for further processing.

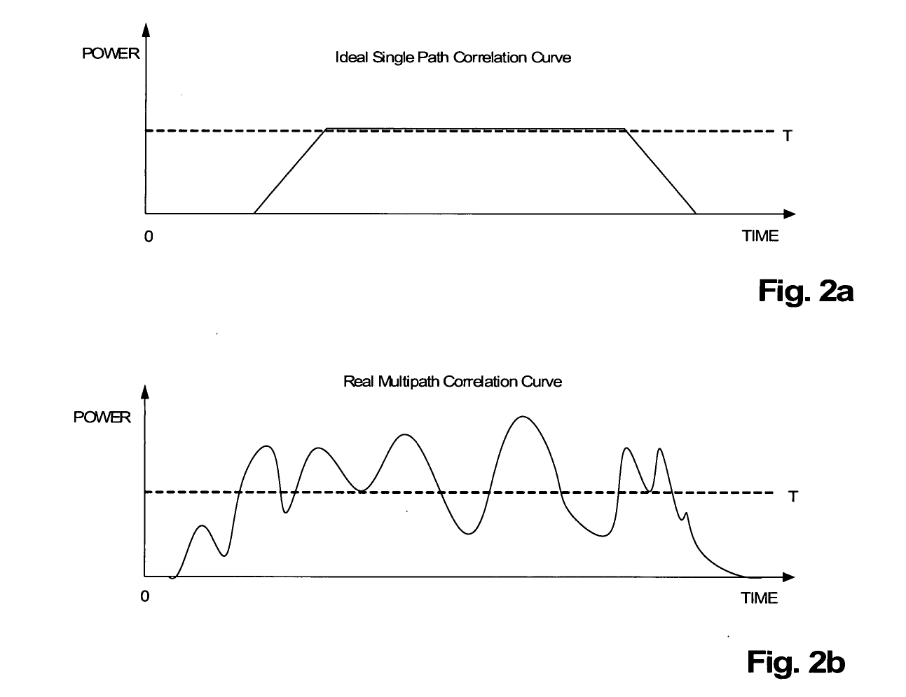

Turning briefly to FIGS. 2a and 2b, two exemplary pilot correlation diagrams are illustrated for purposes of clarity as well as to facilitate appreciation of one of the problems identified and overcome. The correlation diagrams or curves depict a correlator output as captured by the magnitude of the detection metric over time. FIG. 2a depicts correlator output in a single path channel without noise. The correlator output clearly has a leading edge, a flat portion, and subsequently a trailing edge. FIG. 2b illustrates an exemplary correlation curve in a multipath channel with noise. Once can observe that there is a pilot there, however it is obscured by channel noise and multipath delay. Conventionally, a single threshold is employed to detect a pilot symbol. In particular, the threshold is used to determine the start of a symbol when the correlation values are greater than the set or predetermined threshold. In the ideal case of FIG. 2a, the threshold would be set close to the flat zone value and a symbol would be detected when it crosses that value. Subsequently, a count would be initiated to determine the trailing edge. Alternatively, the trailing edge could simply be detected when the curve values dip below the threshold. Unfortunately, such conventional methods and techniques are not effective in a real multipath environment. As can be ascertained from FIG. 2b, the leading edge cannot readily be determined from the correlation values as multipath can cause the values to be spread and noise can further obscure the leading edge. This can result in a large number of false positive detections. Furthermore, the spreading of the signal is not conducive to counting samples to detect a trailing edge and noise will prohibit detection of a trailing edge when values dip below the threshold. The techniques disclosed herein provide a robust system and method of pilot and frame detection in a real world multipath environment.

Turning back to FIG. 1, leading edge component 120 can be employed to detect a potential leading edge of a correlation curve. Leading edge component 120 receives a series of detection metric values (Sₙ) from the delayed correlator component 120. Upon receipt, the value is compared to a fixed or programmable threshold (T). In particular, a determination is made as to whether Sₙ>=T. If it is, then a count or counter (e.g., run count) is incremented. Alternatively, if Sₙ<T then the counter can be set to zero. The counter thereby stores the number of consecutive correlation output values that are above the threshold. Leading edge component 120 monitors this counter to ensure that a predetermined or programmed number of samples have been analyzed. According to an embodiment, this can correspond to when the run count=64. However, it should be appreciated that this value can be modified to optimize detection in a particular system in a specific environment. This technique is advantageous in that it makes it less likely, that a leading edge will be falsely detected as a result of initial noise or spreading, because the samples must consecutively stay above a threshold for a length of time. Once the condition(s) are satisfied, the leading edge component can declare detection of a potential leading edge. Subsequently, a signal can be provided to confirmation component 130 indicating such.

As the name suggests, confirmation component 130 is operable to confirm that a leading edge was indeed detected by the leading edge component 120. Following a leading edge, a lengthy flat period is expected. Hence, if the flat portion is detected then this increases the confidence that the leading edge of the pilot symbol was detected by the leading edge component 120. If not, then a new leading edge will need to be detected. Upon receipt of a signal from the leading edge component 120, the confirmation component 130 can begin to receive and analyze additional detection metric values (Sₙ).

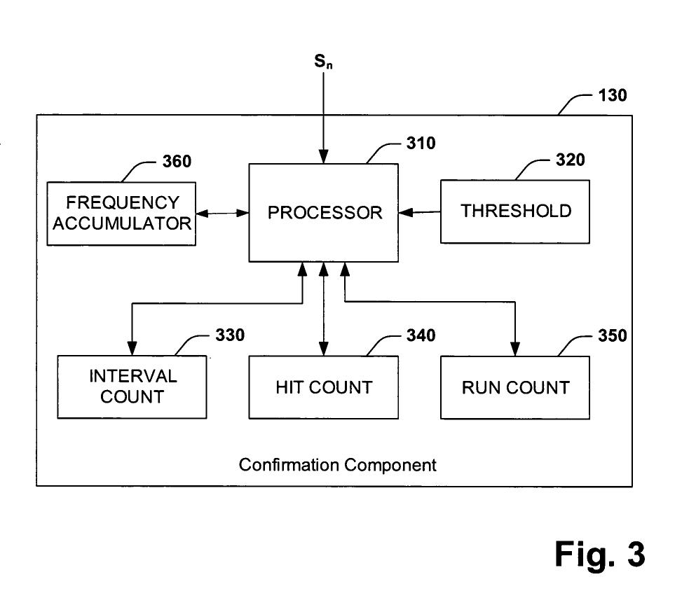

Turning to FIG. 3, a block diagram of one exemplary implementation of the confirmation component 130 is depicted to facilitate clarity in understanding.

Confirmation component 130 can include or be associated with a processor 310, a threshold value 320, an interval count 330, a hit count 340, a run count 350, and a frequency accumulator 360. Processor 310 is communicatively coupled with threshold 320, interval counter 330, hit counter 340, run counter 350, and the frequency accumulator 360. Furthermore, processor 310 is operable to receive and/or retrieve correlation values Sₙ as well as interact (e.g., receive and transmit signals) with leading edge component 120 (FIG. 1) and trailing edge component 140 (FIG. 1). The threshold value 320 can be the same threshold as was employed by the leading edge component 120 (FIG. 1). Furthermore, it should be noted that while the threshold value is illustrated as part of the confirmation component 130 as a hard coded value, for instance, the threshold value 320 can be received and/or retrieved from outside the component to, among other things, facilitate programming of such value. In brief, interval count 330 can be used in determining when to update a frequency locked loop to determine frequency offset via frequency accumulator 360 as well as detecting the trailing edge. Hit count 340 can be utilized to detect the symbol flat zone and run count 350 is used to identify a trailing edge.

Prior to initial processing of correlation values, the processor 310 can initialize each of the counters 330, 340, and 350, as well as the frequency accumulator 360 to zero, for example. The processor 310 can then receive or retrieve a correlation output Sₙ and the threshold 420. The interval count 430 can then be incremented to note that a new sample has been retrieved. Each time a new correlation sample is retrieved the interval count 430 can be incremented. The processor 310 can subsequently compare the correlation value to threshold 320. If Sₙ is greater than or equal to the threshold, then the hit count can be incremented. As per the run count, it can be incremented if Sₙ is less then the threshold 320; otherwise, it is set to zero. Similar to the leading edge, run count can indicate the number of consecutive samples below threshold. The count values can be analyzed to determine whether a leading edge has been detected, whether there was a false positive, or whether the leading edge was otherwise missed (e.g., got in to late), among other things.

In one embodiment, the confirmation component 130 can determine that the leading edge component 120 detected a false leading, edge by examining the run count and the hit count. Since the confirmation component should be detecting a flat zone of the correlation curve where the values are greater than or equal to the threshold, if the hit count is sufficiently low and the run count is greater than a set value or the hit count and the run count are substantially equal, then it can be determined that noise may have caused incorrect detection of a leading edge. In particular, it can be noted that the received correlation values are not consistent with what is expected. According to one embodiment, the determination that a false leading edge can be detected when the run count is greater than or equal to 128 and the hit count is less than 400.

A determination can be made by the confirmation component 130 that the leading edge was missed or otherwise detected too late for proper timing by again comparing the values of the run count and the hit count. In particular, if the hit count and the run count are sufficiently large such a determination can be made. In one embodiment, this can be decided when the run count is greater than or equal to 786 and the hit count is greater than or equal to 400. Of course, and as with all specific values provided herein, the values can be optimized or adjusted for a particular frame structure and/or environment.

It should be appreciated that the confirmation component 130 can begin to detect the trailing edge of the curve while it is analyzing the flat zone to decide if a proper leading edge was detected. If the trailing edge is detected, the confirmation component can be successfully terminated. To detect the trailing edge, the interval count and the run count can be employed. As noted above, the interval count includes the number of input samples received and correlated. The length of the flat zone is known to be within a particular count. Hence, if after detecting a potential leading edge and receiving a proper number of flat zone samples there is some evidence of a trailing edge, then the confirmation component can declare detection of the trailing edge. The evidence of a trailing edge can be provided by the run count, which counts the number of consecutive times the correlation value is below the threshold. In one embodiment the confirmation component 130 can declare detection of the trailing edge when the interval count is greater than or equal to 34*128 (4352) and the run count is greater than zero.

If the confirmation component fails to detect any one of the above three conditions then it can simply continue to receive correlation values and update the counters. If one of the conditions is detected, the processor can provide one or more additional checks on the counters to increase the confidence that one of the conditions has actually occurred. In particular, the processor 310 can insist upon a minimum number of hits in the flat zone as that is what it expected to observe after the leading edge detection. For instance, the processor can test whether the hit count is greater than a set value such as 2000. According to one embodiment of a frame structure disclosed herein, the expected number of hits in the flat zone should be 34*128, which over 4,000. However, noise will temper the actual results so the gating value can be set somewhat below 4,000. If the additional conditions are met, the confirmation component 130 can provide a signal to the trailing edge component alternatively the confirmation component can signal the leading edge component to locate a new leading edge.

It should also be appreciated that the confirmation component 130 can also provide additional functionality such as saving time instances and updating frequencies.

The subject frame detection system 100 of FIG. 1 is providing course detection of the frame and symbol boundaries. Accordingly, some fine-tuning will need to be performed at a later time to get synchronization that is more precise. Accordingly, at least one time reference should be saved for use later by a fine timing system and/or method. According to one embodiment, every time the run count is equal to zero. A time instance can be saved as an estimate of the last time for the correlation curve flat zone or the time just prior to detecting the trailing edge. Furthermore, proper synchronization necessitates locking on the appropriate frequency. Hence, the processor 310 can update a frequency locked loop utilizing the frequency accumulator 360 at particular times such as when the input is periodic. According to one embodiment, the frequency locked loop can be updated every 128 input samples as tracked by the interval counter, for instance.

Returning to FIG. 1, trailing edge component 140 can be employed to detect the trailing edge if not detected by the confirmation component 130. In sum, trailing edge component 140 is operable to detect the trailing edge or simply time out such that another leading edge can be detected by leading edge component 120.

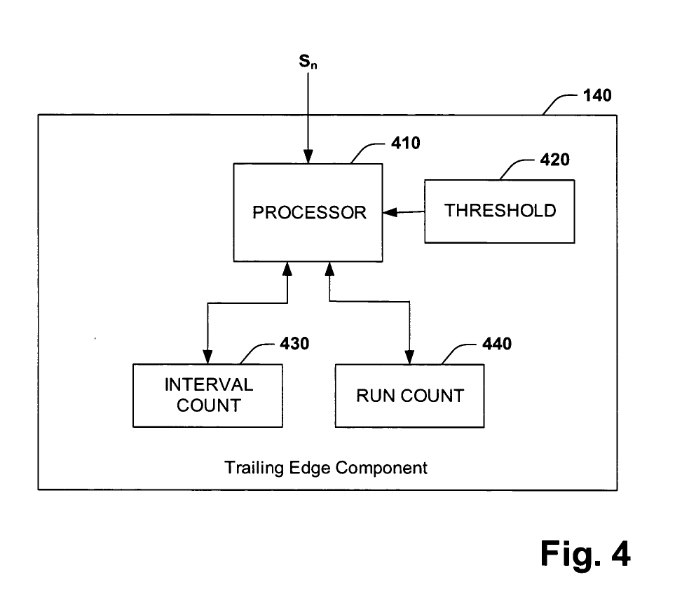

Turning to FIG. 4 an embodiment of a trailing edge component 140 is illustrated.

The trailing edge component 140 can include or be associated with processor 410, a threshold 420, an interval count 430 and a run count 440. Similar to the other detection components, trailing edge component 140 can receive a plurality of correlation values from the delayed correlator component 110 and increment appropriate counts to facilitate detection of a correlation curve trailing edge associated with a first TDM pilot symbol. In particular, processor 410 can compare the correlation value with the threshold 420 and populate either or both of the interval count 430 and the run count 440. It should be noted that although the threshold 420 is illustrated as part of the trailing edge component it could also be received or retrieved from outside the component such as from a central programmatic location. It should also be appreciated of course that processor 410 can, prior to its first comparison, initialize the interval count 430 and a run count 440 to zero. The interval count 430 stores the number of correlation outputs received. Thus, with each received or retrieved correlation value, the processor 410 can increment the interval count 430. The run count stores the consecutive number of times the correlation value or output is less than the threshold 420. If the correlation value is less than a threshold then the processor 410 can increment the run count 440, otherwise run count 440 can be set to zero. The trailing edge component 140 via processor 410, for example, can test whether an interval count value or a run count value has been satisfied utilizing the interval count 430 and or the run count 440. For instance, if the run count 440 attains a certain value the trailing edge component can declare detection of a trailing edge. If not, the trailing edge component 140 can continue to receive correlation values and update the counts. If, however, the interval count 430 becomes sufficiently large this can indicate that the trailing edge will not be detected and a new leading edge needs to be located. In one embodiment, this value can be 8*128(1024). On the other hand, if the run count 440 hits or exceeds a value this can indicate that a trailing edge has been detected. According to an embodiment, this value can be 32.

Additionally, it should be appreciated that trailing edge component 140 can also save time instances for use in acquisition of fine timing. According to an embodiment, the trailing edge component 140 can save the time instance whenever the run count equals zero thereby providing a time instance just prior to trailing edge detection. According to one embodiment and the frame structure described infra, the saved time instance can correspond to the 256^{th} sample in the next OFDM symbol (TDM pilot-2). A fine frame detection system can subsequently improve upon that value as discussed in later sections.

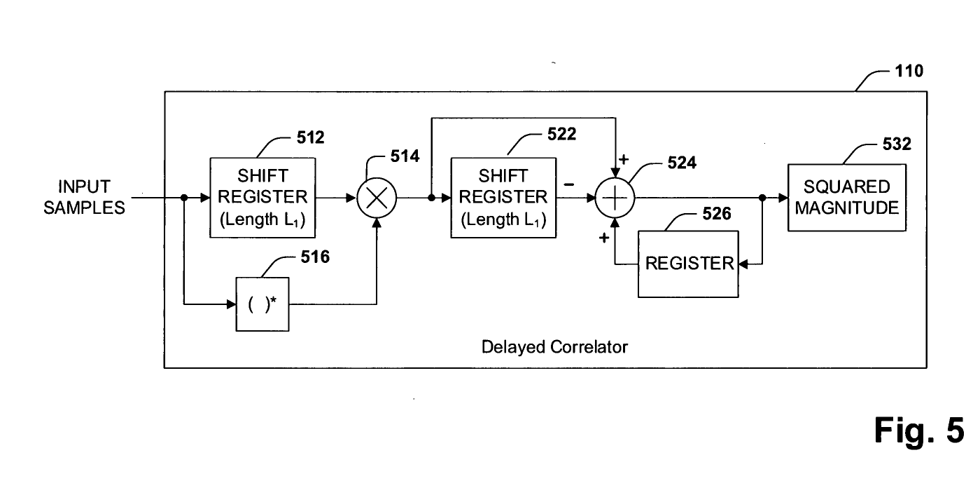

FIG. 5 illustrates a delayed correlator component 110 in further detail in accordance with one embodiment. The delayed correlator component 110 exploits the periodic nature of the pilot-1 OFDM symbol for frame detection. In an embodiment, correlator 110 uses the following detection metric to facilitate frame detection:

$${S}_{n} = {\vert {\sum }_{i = n - {L}_{1} + 1}^{n} {r}_{i - {L}_{1}} \cdot {r}_{i}^{*} \vert}^{2} , \qquad ( 1 )$$

Where Sₙ is the detection metric for sample period n,
“*” denotes a complex conjugate, and
   |x|² denotes the squared magnitude of x.
   Equation (1) computes a delayed correlation between two input samples rᵢ and r_{i-L}_{₁} in two consecutive pilot-1 sequences, or cᵢ=r_{i-L}_{₁}·rᵢ*. This delayed correlation removes the effect of the communication channel without requiring a channel gain estimate and further coherently combines the energy received via the communication channel. Equation (1) then accumulates the correlation results for all L₁ samples of a pilot-1 sequence to obtain an accumulated correlation result Cₙ, which is a complex value. Equation (1) then derives the decision metric or correlation output Sₙ for sample period n as the squared magnitude Cₙ. The decision metric Sₙ is indicative of the energy of one received pilot-1 sequence of length L₁, if there is a match between the two sequences used for the delayed correlation.

Within delayed correlator component 110, a shift register 512 (of length L₁) receives, stores, and shifts the input samples {rₙ} and provides input samples {r_{n-L}_{₁}} that have been delayed by L₁ sample periods. A sample buffer may also be used in place of shift register 512. A unit 516 also receives the input samples and provides the complex-conjugated input samples {rₙ*}. For each sample period n, a multiplier 514 multiplies the delayed input sample r_{n-L}_{₁} from shift register 512 with the complex-conjugated input sample rₙ* from unit 516 and provides a correlation result cₙ to a shift register 522 (of length L₁) and a summer 524. Lower-case cₙ denotes the correlation result for one input sample, and upper case Cₙ denotes the accumulated correlation result for L₁ input samples. Shift register 522 receives, stores, and delays the correlation results {cₙ} from multiplier 514 and provides correlation results {c_{n-L}_{₁}} that have been delayed by L₁ sample periods. For each sample period n, summer 524 receives and sums the output Cₙ₋₁ of a register 426 with the result cₙ from multiplier 414, further subtracts the delayed result c_{n-L}_{₁} from shift register 522, and provides its output Cₙ to register 526. Summer 524 and register 426 form an accumulator that performs the summation operation in equation (1). Shift register 522 and summer 524 are also configured to perform a running or sliding summation of the L₁ most recent correlation results cₙ through c_{n-L}_{₁}₊₁. This is achieved by summing the most recent correlation result cₙ from multiplier 514 and subtracting out the correlation result c_{n-L}_{₁} from L₁ sample periods earlier, which is provided by shift register 522. A unit 532 computes the squared magnitude of the accumulated output Cₙ from summer 524 and provides the detection metric Sₙ.

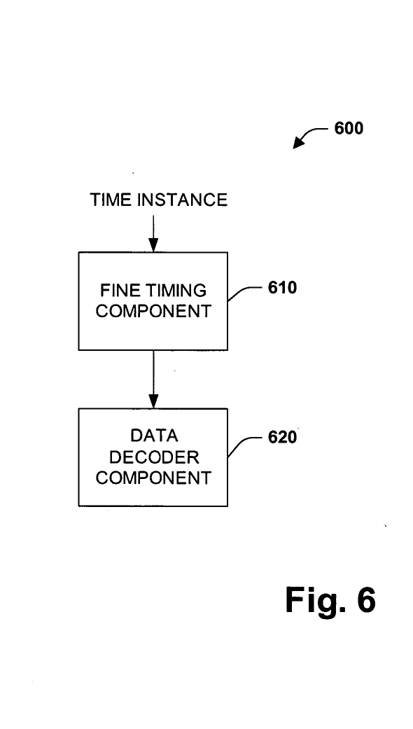

FIG. 6 depicts a fine frame detection system 600. System 650 includes a fine timing component 610 and a data decoder component 620. Fine timing component 610 can receive the time instance saved by the coarse frame detection system 100 (FIG. 1). As mentioned above, this time instance can correspond to the 256^{th} sample of the next OFDM symbol, which can be TDM pilot-2. This is somewhat arbitrary yet optimized for multipath. The fine timing component 610 can then utilize the TDM pilot-2 symbol to improve upon this coarse timing estimate (T_{c}). There are many mechanisms to facilitate fine timing including those known in the art. According to one embodiment herein, a frequency-locked loop or automatic frequency control loop can be switched from acquisition to tracking mode, which utilizes a different algorithm to compute error and a different tracking loop bandwidth. Data decoder component 620 can attempt to decode one or more data OFDM symbols. This is an extra step providing for additional confidence that the synchronization has been accomplished. If the data does not decode, a new leading edge will have to be detected again by the leading edge component 120 (FIG. 1). Further detail concerning fine timing is provided infra.

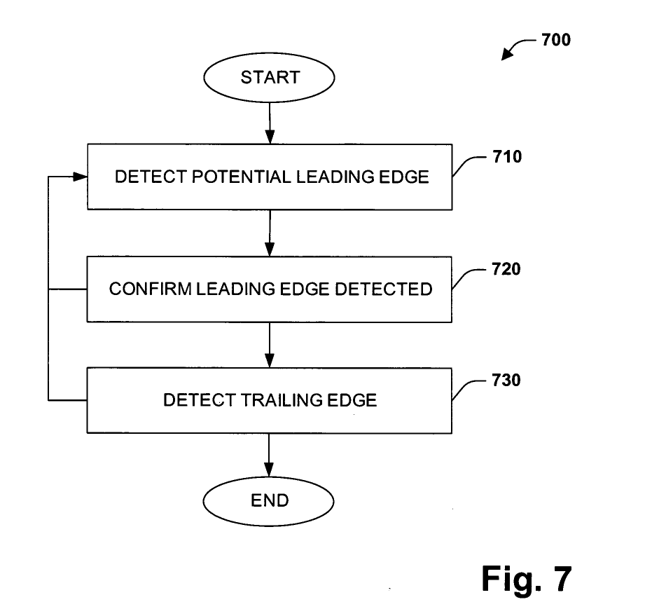

In view of the exemplary systems described supra, a methodology that may be implemented will be better appreciated with reference to the flow charts of FIGS. 7-12. While for purposes of simplicity of explanation, the methodology is shown and described as a series of blocks, it is to be understood and appreciated that it is not limited by the order of the blocks, as some blocks may occur in different orders and/or concurrently with other blocks from what is depicted and described herein. Moreover, not all illustrated blocks may be required to implement the disclosed methodology.

Additionally, it should be further appreciated that the methodologies disclosed hereinafter and throughout this specification are capable of being stored on an article of manufacture to facilitate transporting and transferring such methodologies to computer devices. The term article of manufacture, as used, is intended to encompass a computer program accessible from any computer-readable device, carrier, or media.

Turning to FIG. 7, a robust method of initial OFDM frame detection is illustrated. The method essentially contains three stages. At 710, the first stage, an attempt is made to observe a pilot symbol leading edge is detected. The leading edge can be detected by analyzing a plurality of detection metrics or correlation output values produced by a delayed correlator. In particular, the detection metrics (Sₙ) or some function thereof (e.g., Sₙ² . . . ) can be compared with a threshold value. Potential detection of the leading edge can then be predicated on the number of times the metric is greater than or equal to the threshold. At 720, the detected leading edge is confirmed by observing additional correlation values and comparing them to the threshold. Here, the correlator output is again compared to the threshold and observations made regarding the number of times the correlator output exceeds the threshold. The process can stay in this stage for greater than or equal to a predetermined period of time (corresponding to the flat zone) or upon detection of a consistent trailing edge. It should also be noted that frequency offset can be obtained here be updating a frequency accumulator periodically. If neither of the confirmation conditions is met, then there was a false detection of a leading edge and the procedure can be initialized and started again at 710. At 730, an attempt is made to observe the trailing edge if not previously observed. If the correlator output remains below the threshold for a number of consecutive samples, for example 32, TDM pilot detection can be declared and initial frequency acquisition assumed to be complete. If this condition is not met then the process can be initialized and started again at 710. The initial OFDM symbol time estimate is based on the trailing edge. The time instance when the correlator output goes below the threshold for the first time during observation of the trailing edge can be views as an index (e.g., 256^{th} sample) into the next OFDM symbol, here TDM pilot-2.

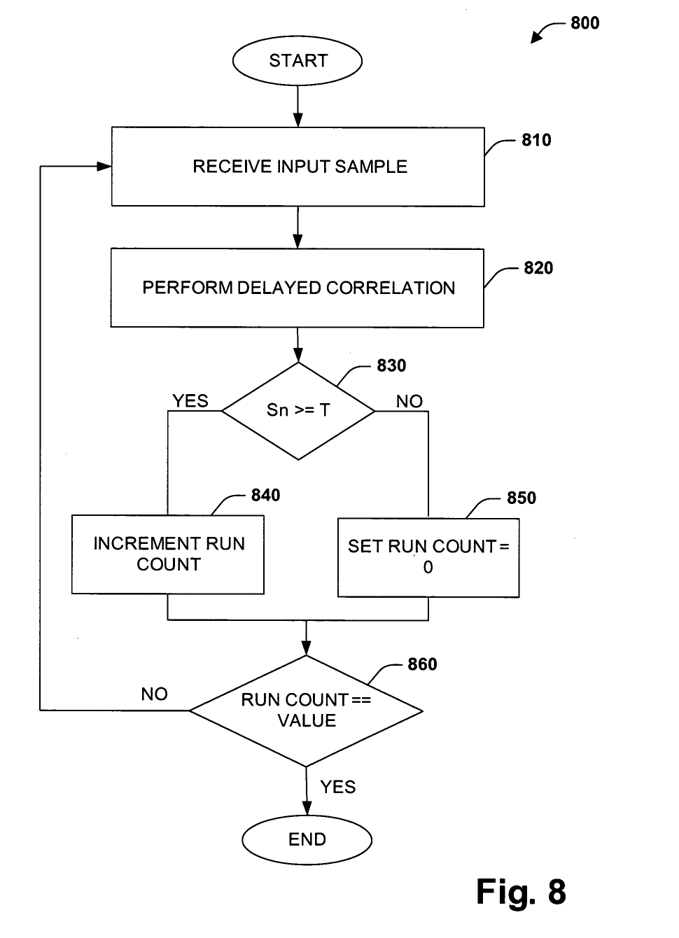

FIG. 8 is a flow chart diagram depicting a leading edge detection methodology 800. At 810, transmitted input symbols are received. A delayed correlation is performed, at 820, on the received input and a delayed version thereof. A correlation output is then provided to decision block 830. At 830, the correlation output is compared with a fixed or programmable threshold value. If the correlation value is greater than or equal to the threshold a run count or counter is incremented at 840. If the correlation value is less then the threshold value then the run count is set to zero, at 850. The run count is then compared, at 860, with a predetermined value that is optimized for detection of a leading edge in a multipath environment. In one embodiment, the value can be 64 input samples. If the run count is equal to the predetermined value, the process is terminated. If the run count is not equal to the value then the additional input values are received at 810 and the process in repeated.

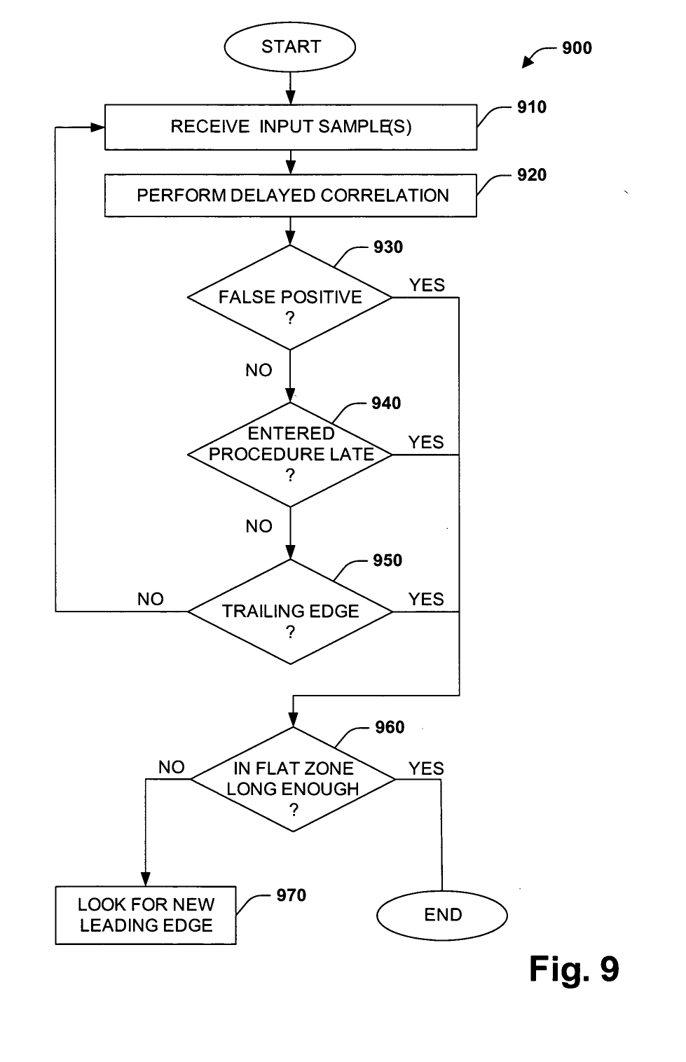

FIG. 9 is a flow chart diagram of leading edge confirmation methodology 900. Methodology 900 represents the second stage in a coarse or initial frame detection methodology, in which a leading edge detection is confirmed (or rejected) via detection of additional expected results namely a flat zone and/or a trailing edge. At 910, one of a myriad of input samples is received. A delayed correlation is performed on the input sample and a delayed version thereof, at 920, to produce a correlation output. A plurality of correlator outputs are then analyzed with respect to a programmable threshold to make subsequent determinations. At 930, a determination is made as to whether a false leading edge was detected, which can result from channel noise, among other things. This determination can be made if not enough correlation output values are above a threshold. At 940, a determination is made as to whether a leading edge was detected too late. In other words, the leading edge was not detected until well into the flat zone region of the pilot. At 950, a determination is made as to whether a trailing edge is being observed. If none of these conditions is true based on the correlation outputs received thus far, the process continues at 910 where more input samples are received. If any one of the conditions is true, the process can continue at 960, were an additional determination is made concerning whether a long enough flat zone has been observed to provide confidence that it was detected. If yes, the procedure can be terminated. If no, the process can proceed with another method, such as method 800 (FIG. 8), to detect a new leading edge. In one embodiment, a new pilot symbol will be transmitted one second after the previous pilot symbol.

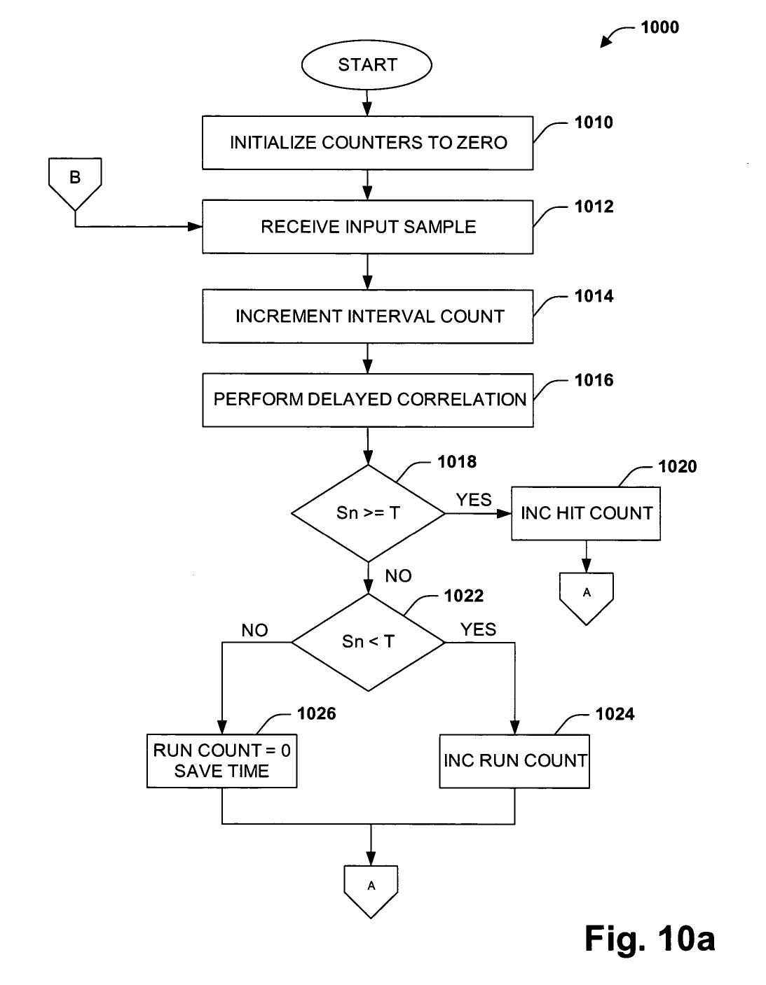

FIG. 10 depicts a more detailed method 1000 of detecting the flat zone and confirming detection of the leading edge in accordance with a particular embodiment. In this particular, process three counts or counters are employed: an interval count, a hit count, and a run count. At 1010, counters are all initialized to zero. At 1012, input samples are received. The interval count is incremented, at 1014, to indicate receipt of an input sample. It should also be appreciate that although not specifically denoted in the block diagram that a frequency loop can be updated every 128 samples as tracked by the interval count. At 1016, delayed correlation is performed utilizing the input sample and a time-delayed version thereof to produce a correlation output (Sₙ). A determination is then made, at 1018, as to whether Sₙ is greater than or equal to a threshold (T). If Sₙ>=T, then the hit count is incremented at 1020 and the process can proceed at 1028. If not, then a determination is made at 1022 as to whether Sₙ<T. If yes, then the run count is incremented at 1024. If no, then the run count is initialized to zero and the time is saved. The saved time therefore provides the time instance prior to observation of a trailing edge. It should be appreciated that decision block 1022 is not strictly necessary here but is provided for clarity as well as to highlight further that the order of such method processes does not need to be fixed as shown. The method continues to 1028 where the hit count and the run count are scrutinized to determine if a false leading edge was detected. In one embodiment, this can correspond to the run count being greater than or equal to 128 and the hit count being less than 400. If it is decided that a false positive was detected the process proceeds to 1036 where a new leading edge is located. If a false positive was not able to be determined then the process continues at decision block 1030. At 1030, the run count and the hit count are analyzed to determine if the leading edge was detected late. According to one specific embodiment, this can correspond to when the run count is greater than or equal to 768 and the hit count is greater than or equal to 400. If this is the case, the process can continue at 1034. If the leading edge was not detected late, then the process proceeds to 1032 where the interval count and the run count are analyzed to determine if a trailing edge is being observed. In one embodiment this can be where the interval count is greater than or equal to the 4352 (34*128) and the run count is greater than zero. In other words, the full length of the flat zone has been detected and a dip below threshold has just been observed. If no, then all three conditions have failed and the process proceeds to 1012 where more input samples are received. If yes, a determination is made at 1034 as enough values have been observed above the threshold to enable the methodology to determine with confidence that the flat zone has been detected. More specifically, the hit count is larger than some programmable value. In one embodiment, the value can be 2000. However, this is some-what arbitrary. Ideally, the process should see 34*128(4352) samples above threshold, but noise can temper the count. Thus, the programmable value can set to an optimal level that provides a particular level of confidence that the flat zone has been detected. If the hit count is greater than the provided value, then the process terminates. If not, the process proceeds to 1036 where a new edge needs to be detected.

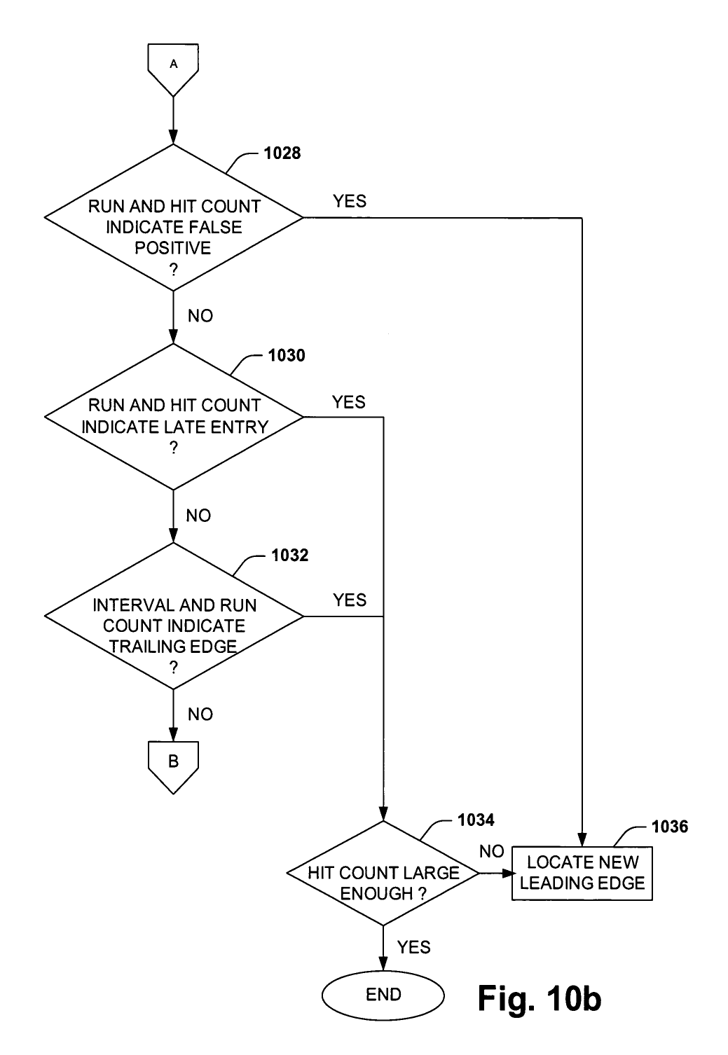

FIG. 11 illustrates one embodiment of a trailing edge detection methodology 1100. Trailing edge methodology can be employed to detect the trailing edge of correlation curve associated with a pilot symbol, if not previously detected. At 1110, counters including an interval and a run counters are initialized to zero. At 1112, input samples are received. The interval count is incremented corresponding to a received sample, at 1114. Each input sample is utilized by a delayed correlator to produce a correlation output Sₙ, at 1116. A decision is made at 1118 regarding with the correlation output Sₙ is less than a programmable threshold (T). If Sₙ<T, then the run count is incremented and the process proceeds to 1126. If the correlation output is not less than the threshold, then the run counter is set to zero at 1122 and the time instance can be saved at 1124. At 1126, a determination is made as to whether enough correlation outputs have been observed consecutively to confidently declare successful identification thereof. In one embodiment, this corresponds to a run time greater than or equal to 32. If the run time is large enough, the process can terminate successfully. If the run time is not large enough, the process proceeds to decision block 1128. At 1128, the interval counter can be employed to determine whether the detection method 1100 should be timed out. In one embodiment if the interval count is equal to 8*128(1024) the trailing edge detection method 1100 times out. If the method does not timeout at 1128, then additional samples can be received and analyzed starting again at 1112. If the method does time out at 1128, then the new pilot leading edge will need to be detected as the method 1100 failed to observe a trailing edge.

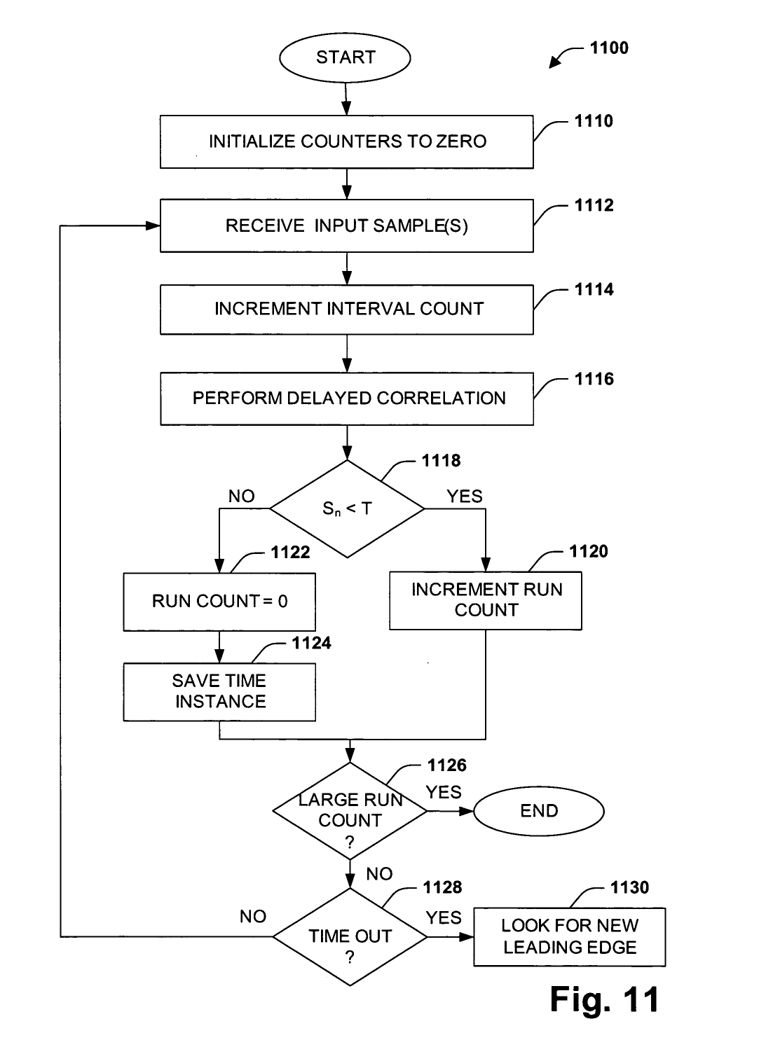

FIG. 12 illustrates a frame synchronization methodology 1200. At 1210, the process first waits for automatic gain control to settle. Automatic gain control adjusts the input single to provide a consistent signal strength or level such that the signal can be processed properly. At 1220, a frequency locked loop accumulator is initialized. At 1214, a potential leading edge is detected. At 1216, the leading edge can be confirmed by detection of a flat zone and/or a trailing edge. If it is determined that a valid leading edge was not detected at 1218, then the procedure starts over at 1210. It should be appreciated also that it is at this point, where the frequency locked loop can be updated periodically via the frequency accumulator, for example to acquire the initial frequency offset. At 1220, the trailing edge can be detected if not previously observed. It is here just prior to the initial dip of the trailing edge that the time can be saved to be used later for fine timing. If the trailing edge is not detected at 1222 and was not previously detected then the process proceeds to 1210 where the method begins again. If the trailing edge was detected then the initial coarse detection has been completed. The procedure continues at 1224 where the frequency locked loop is switch to tracking mode. Fine timing is acquired utilizing a second TDM pilot symbol and information provided by the prior coarse estimate. In particular, the time instance saved (T_{c}) can correspond to a particular sample offset within the second pilot symbol. In accordance with one embodiment, the saved time sample can correspond to the 256^{th} sample in the second pilot symbol. Specific algorithms can them be utilized to improve upon that timing estimate as described in later sections. Upon termination of fine timing acquisition, one or more data symbols can be retrieved and an attempt made to decode such symbols, at 1228. If, at 1230, the decoding was successful then the process terminates. However, if the process was not successful then the methodology starts over at 1212.

The following is a discussion one of a plurality of suitable operating environments to provide context for particular inventive aspects described supra. Further, in the interest of clarity and understanding a detailed description is provided of one embodiment of time division multiplexed pilots—TDM pilot-1 and TDM pilot-2.

The synchronization techniques described below and throughout may be used for various multi-carrier systems and for the downlink as well as the uplink. The downlink (or forward link) refers to the communication link from the access points to the access terminals, and the uplink (or reverse link) refers to the communication link from the access terminals to the access points. For clarity, these techniques are described below for the downlink in an OFDM system.

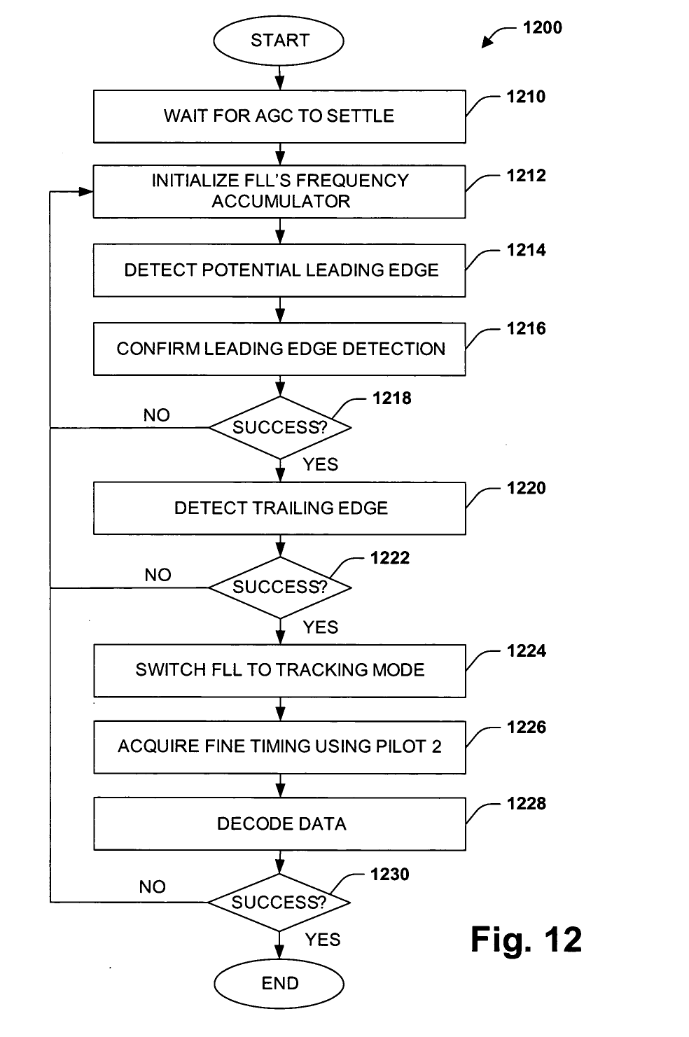

FIG. 13 shows a block diagram of an access point (AP) 1310 and an access terminal (AT) 1350 in an OFDM system 1300. Access point 1310 is generally a fixed station and may also be referred to as a base transceiver system (BTS), base station, or some other terminology. Access terminal 1350 may be fixed or mobile and may also be referred to as a user terminal, a mobile station, or some other terminology. Access terminal 1350 may also be a portable unit such as a cellular phone, a handheld device, a wireless module, a personal digital assistant (PDA), and the like.

At access point 1310, a TX data and pilot processor 1320 receives different types of data (e.g., traffic/packet data and overhead/control data) and processes (e.g., encodes, interleaves, and symbol maps) the received data to generate data symbols. As used herein, a “data symbol” is a modulation symbol for data, a “pilot symbol” is a modulation symbol for pilot, and a modulation symbol is a complex value for a point in a signal constellation for a modulation scheme (e.g., M-PSK, M-QAM, and so on). Processor 1320 also processes pilot data to generate pilot symbols and provides the data and pilot symbols to an OFDM modulator 1330.

OFDM modulator 1330 multiplexes the data and pilot symbols onto the proper subbands and symbol periods and further performs OFDM modulation on the multiplexed symbols to generate OFDM symbols, as described below. A transmitter unit (TMTR) 1332 converts the OFDM symbols into one or more analog signals and further conditions (e.g., amplifies, filters, and frequency upconverts) the analog signal(s) to generate a modulated signal. Access point 1310 then transmits the modulated signal from an antenna 1334 to access terminals in the system.

At access terminal 1350, the transmitted signal from access point 1310 is received by an antenna 1352 and provided to a receiver unit (RCVR) 1354. Receiver unit 1354 conditions (e.g., filters, amplifies, and frequency downconverts) the received signal and digitizes the conditioned signal to obtain a stream of input samples. An OFDM demodulator 1360 performs OFDM demodulation on the input samples to obtain received data and pilot symbols. OFDM demodulator 1360 also performs detection (e.g., matched filtering) on the received data symbols with a channel estimate (e.g., a frequency response estimate) to obtain detected data symbols, which are estimates of the data symbols sent by access point 1310. OFDM demodulator 1360 provides the detected data symbols to a receive (RX) data processor 1370.

A synchronization/channel estimation unit 1380 receives the input samples from receiver unit 1354 and performs synchronization to determine frame and symbol timing, as described above and below. Unit 1380 also derives the channel estimate using received pilot symbols from OFDM demodulator 1360. Unit 1380 provides the symbol timing and channel estimate to OFDM demodulator 1360 and may provide the frame timing to RX data processor 1370 and/or a controller 1390. OFDM demodulator 1360 uses the symbol timing to perform OFDM demodulation and uses the channel estimate to perform detection on the received data symbols.

RX data processor 1370 processes (e.g., symbol demaps, deinterleaves, and decodes) the detected data symbols from OFDM demodulator 1360 and provides decoded data. RX data processor 1370 and/or controller 1390 may use the frame timing to recover different types of data sent by access point 1310. In general, the processing by OFDM demodulator 1360 and RX data processor 1370 is complementary to the processing by OFDM modulator 1330 and TX data and pilot processor 1320, respectively, at access point 1310.

Controllers 1340 and 1390 direct operation at access point 110 and access terminal 1350, respectively. Memory units 1342 and 1392 provide storage for program codes and data used by controllers 1340 and 1390, respectively.

Access point 1310 may send a point-to-point transmission to a single access terminal, a multi-cast transmission to a group of access terminals, a broadcast transmission to all access terminals under its coverage area, or any combination thereof.

For example, access point 1310 may broadcast pilot and overhead/control data to all access terminals under its coverage area. Access point 1310 may further transmit user-specific data to specific access terminals, multi-cast data to a group of access terminals, and/or broadcast data to all access terminals.

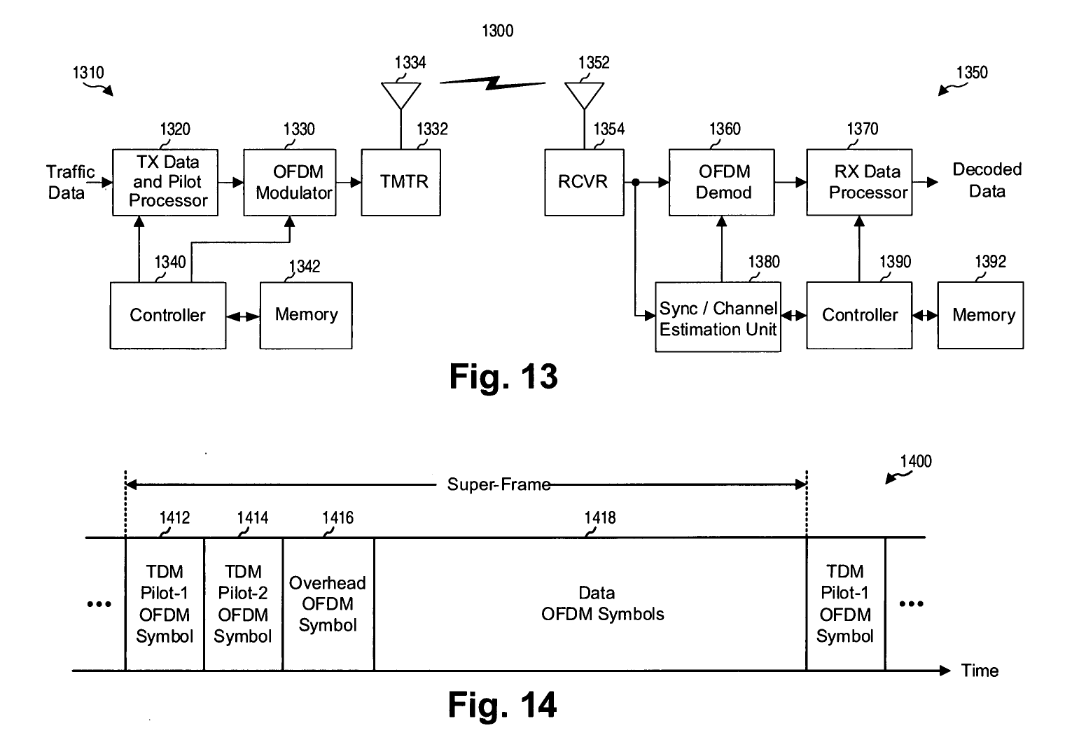

FIG. 14 shows a super-frame structure 1400 that may be used for OFDM system 1300. Data and pilot may be transmitted in super-frames, with each super-frame having predetermined time duration (e.g., one second). A super-frame may also be referred to as a frame, a time slot, or some other terminology. For the embodiment shown in FIG. 14, each super-frame includes a field 1412 for a first TDM pilot (or “TDM pilot-1”), a field 1414 for a second TDM pilot (or “TDM pilot-2”), a field 1416 for overhead/control data, and a field 1418 for traffic/packet data.

The four fields 1412 through 1418 are time division multiplexed in each super-frame such that only one field is transmitted at any given moment. The four fields are also arranged in the order shown in FIG. 14 to facilitate synchronization and data recovery. Pilot OFDM symbols in fields 1412 and 1414, which are transmitted first in each super-frame, may be used for detection of overhead OFDM symbols in field 1416, which is transmitted next in the super-frame. Overhead information obtained from field 1416 may then be used for recovery of traffic/packet data sent in field 1418, which is transmitted last in the super-frame.

In an embodiment, field 1412 carries one OFDM symbol for TDM pilot-i, and field 1414 also carries one OFDM symbol for TDM pilot-2. In general, each field may be of any duration, and the fields may be arranged in any order. TDM pilot-1 and TDM pilot-2 are broadcast periodically in each frame to facilitate synchronization by the access terminals. Overhead field 1416 and/or data field 1418 may also contain pilot symbols that are frequency division multiplexed with data symbols, as described below.

The OFDM system has an overall system bandwidth of BW MHz, which is partitioned into N orthogonal subbands using OFDM. The spacing between adjacent subbands is BW/N MHz. Of the N total subbands, M subbands may be used for pilot and data transmission, where M<N, and the remaining N−M subbands may be unused and serve as guard subbands. In an embodiment, the OFDM system uses an OFDM structure with N=4096 total subbands, M=4000 usable subbands, and N−M=96 guard subbands. In general, any OFDM structure with any number of total, usable, and guard subbands may be used for the OFDM system.

As described supra, TDM pilots 1 and 2 may be designed to facilitate synchronization by the access terminals in the system. An access terminal may use TDM pilot-1 to detect the start of each frame, obtain a coarse estimate of symbol timing, and estimate frequency error. The access terminal may subsequently use TDM pilot-2 to obtain more accurate symbol timing.

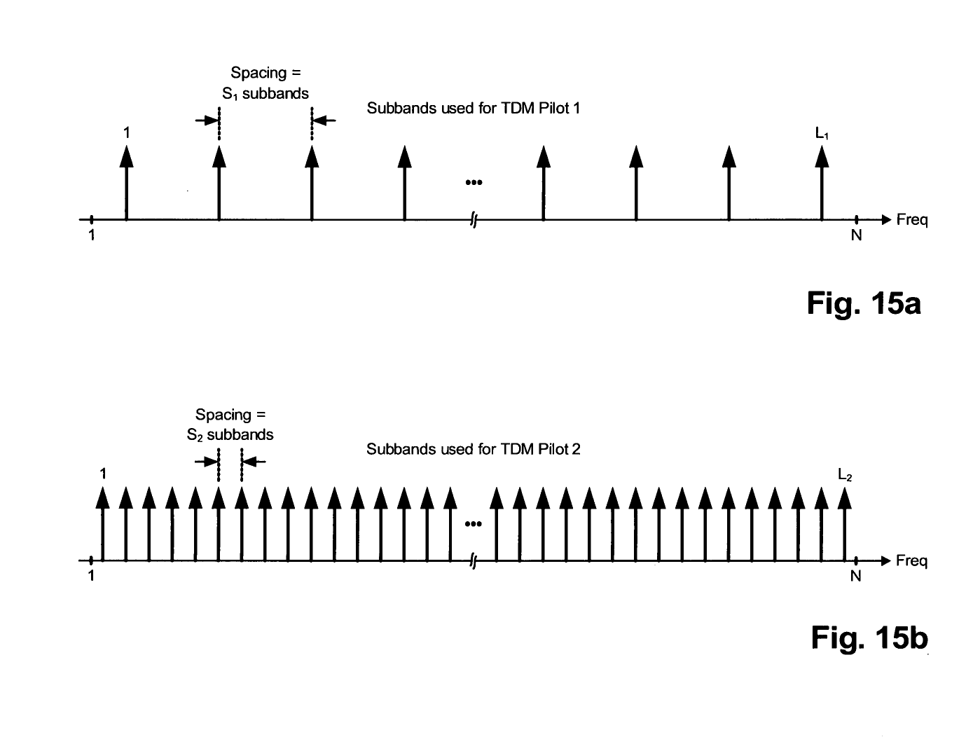

FIG. 15a shows an embodiment of TDM pilot-1 in the frequency domain. For this embodiment, TDM pilot-1 comprises L₁ pilot symbols that are transmitted on L₁ subbands, one pilot symbol per subband used for TDM pilot-1. The L₁ subbands are uniformly distributed across the N total subbands and are equally spaced apart by S₁ subbands, where S₁=N/L₁. For example, N=4096, L₁=128, and S₁=32. However, other values may also be used for N, L₁, and S₁. This structure for TDM pilot-1 can (1) provide good performance for frame detection in various types of channel including a severe multi-path channel, (2) provide a sufficiently accurate frequency error estimate and coarse symbol timing in a severe multi-path channel, and (3) simplify the processing at the access terminals, as described below.

FIG. 15b shows an embodiment of TDM pilot-2 in the frequency domain. For this embodiment, TDM pilot-2 comprises L₂ pilot symbols that are transmitted on L₂ subbands, where L₂>L₁. The L₂ subbands are uniformly distributed across the N total subbands and are equally spaced apart by S₂ subbands, where S₂=N/L₂. For example, N=4096, L₂=2048, and S₂=2. Again, other values may also be used for N, L₂, and S₂. This structure for TDM pilot-2 can provide accurate symbol timing in various types of channel including a severe multi-path channel. The access terminals may also be able to (1) process TDM pilot-2 in an efficient manner to obtain symbol timing prior to the arrival of the next OFDM symbol, which is can occur immediately after TDM pilot-2, and (2) apply the symbol timing to this next OFDM symbol, as described below.

A smaller value is used for L₁ so that a larger frequency error can be corrected with TDM pilot-1. A larger value is used for L₂ so that the pilot-2 sequence is longer, which allows an access terminal to obtain a longer channel impulse response estimate from the pilot-2 sequence. The L₁ subbands for TDM pilot-1 are selected such that S₁ identical pilot-1 sequences are generated for TDM pilot-1. Similarly, the L₂ subbands for TDM pilot-2 are selected such that S₂ identical pilot-2 sequences are generated for TDM pilot-2.

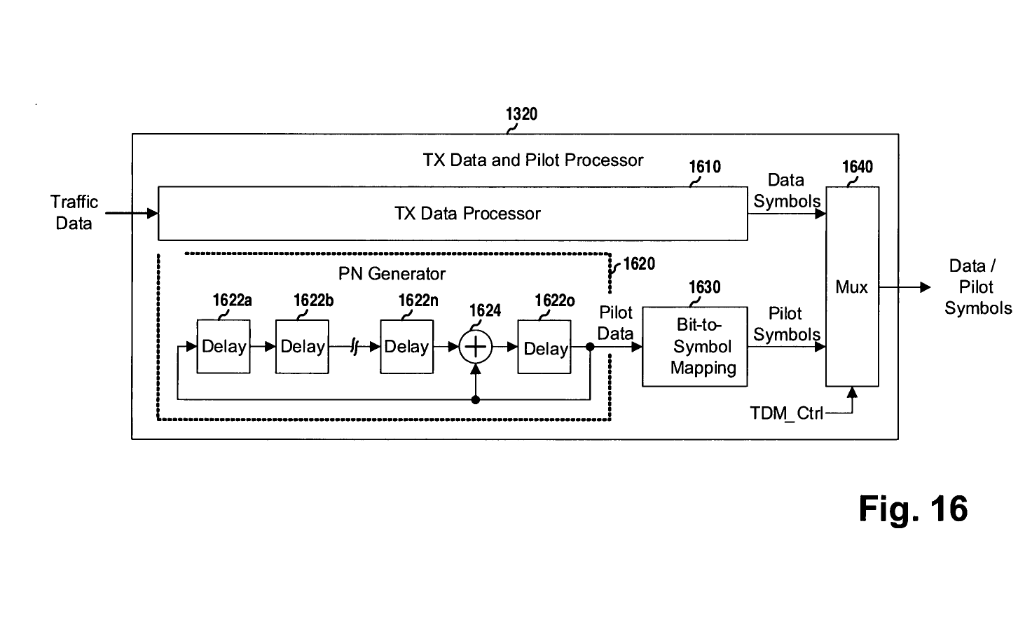

FIG. 16 shows a block diagram of an embodiment of TX data and pilot processor 1320 at access point 1310. Within processor 1320, a TX data processor 1610 receives, encodes, interleaves, and symbol maps traffic/packet data to generate data symbols.

In an embodiment, a pseudo-random number (PN) generator 1620 is used to generate data for both TDM pilots 1 and 2. PN generator 1620 may be implemented, for example, with a 15-tap linear feedback shift register (LFSR) that implements a generator polynomial g(x)=x¹⁵+x¹⁴+1. In this case, PN generator 1620 includes (1) 15 delay elements 1622a through 1622o coupled in series and (2) a summer 1624 coupled between delay elements 1622n and 1622o. Delay element 1622o provides pilot data, which is also fed back to the input of delay element 1622a and to one input of summer 1624. PN generator 1620 may be initialized with different initial states for TDM pilots 1 and 2, e.g., to ‘011010101001110’ for TDM pilot-1 and to ‘010110100011100’ for TDM pilot-2. In general, any data may be used for TDM pilots 1 and 2. The pilot data may be selected to reduce the difference between the peak amplitude and the average amplitude of a pilot OFDM symbol (i.e., to minimize the peak-to-average variation in the time-domain waveform for the TDM pilot). The pilot data for TDM pilot-2 may also be generated with the same PN generator used for scrambling data. The access terminals have knowledge of the data used for TDM pilot-2 but do not need to know the data used for TDM pilot-1.

A bit-to-symbol mapping unit 1630 receives the pilot data from PN generator 1620 and maps the bits of the pilot data to pilot symbols based on a modulation scheme. The same or different modulation schemes may be used for TDM pilots 1 and 2. In an embodiment, QPSK is used for both TDM pilots 1 and 2. In this case, mapping unit 1630 groups the pilot data into 2-bit binary values and further maps each 2-bit value to a specific pilot modulation symbol. Each pilot symbol is a complex value in a signal constellation for QPSK. If QPSK is used for the TDM pilots, then mapping unit 1630 maps 2L₁ pilot data bits for TDM pilot 1 to L₁ pilot symbols and further maps 2L₂ pilot data bits for TDM pilot 2 to L₂ pilot symbols. A multiplexer (Mux) 440 receives the data symbols from TX data processor 1610, the pilot symbols from mapping unit 1630, and a TDM_Ctrl signal from controller 1340. Multiplexer 1640 provides to OFDM modulator 1330 the pilot symbols for the TDM pilot 1 and 2 fields and the data symbols for the overhead and data fields of each frame, as shown in FIG. 14.

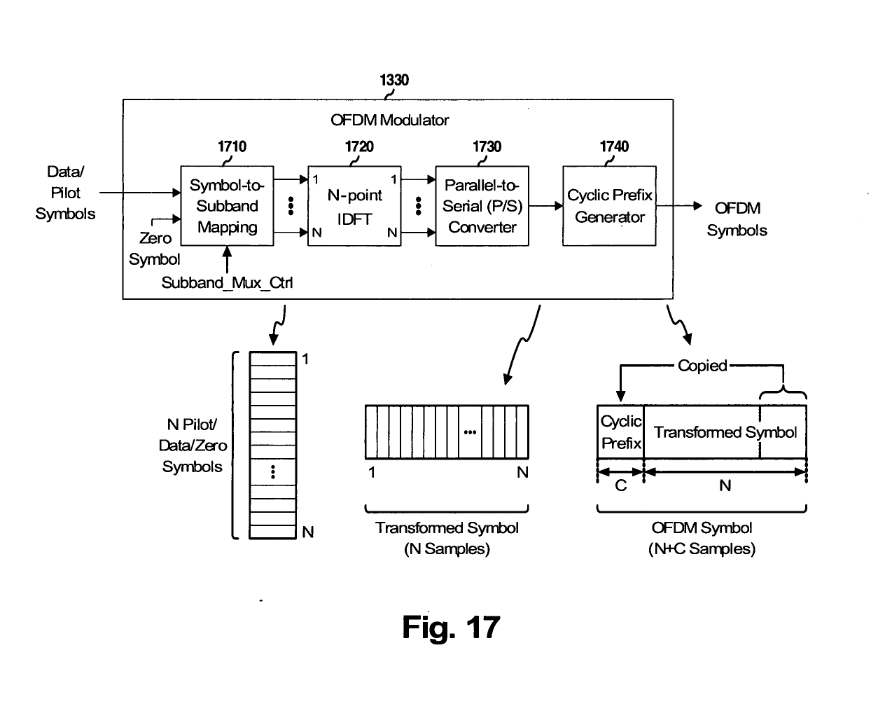

FIG. 17 shows a block diagram of an embodiment of OFDM modulator 1330 at access point 1310. A symbol-to-subband mapping unit 1710 receives the data and pilot symbols from TX data and pilot processor 1320 and maps these symbols onto the proper subbands based on a Subband_Mux_Ctrl signal from controller 1340. In each OFDM symbol period, mapping unit 1710 provides one data or pilot symbol on each subband used for data or pilot transmission and a “zero symbol” (which is a signal value of zero) for each unused subband. The pilot symbols designated for subbands that are not used are replaced with zero symbols. For each OFDM symbol period, mapping unit 1710 provides N “transmit symbols” for the N total subbands, where each transmit symbol may be a data symbol, a pilot symbol, or a zero symbol. An inverse discrete Fourier transform (IDFT) unit 1720 receives the N transmit symbols for each OFDM symbol period, transforms the N transmit symbols to the time domain with an N-point IDFT, and provides a “transformed” symbol that contains N time-domain samples. Each sample is a complex value to be sent in one sample period. An N-point inverse fast Fourier transform (IFFT) may also be performed in place of an N-point IDFT if N is a power of two, which is typically the case. A parallel-to-serial (P/S) converter 1730 serializes the N samples for each transformed symbol. A cyclic prefix generator 1740 then repeats a portion (or C samples) of each transformed symbol to form an OFDM symbol that contains N+C samples. The cyclic prefix is used to combat inter-symbol interference (ISI) and intercarrier interference (ICI) caused by a long delay spread in the communication channel. Delay spread is the time difference between the earliest arriving signal instance and the latest arriving signal instance at a receiver. An OFDM symbol period (or simply, a “symbol period”) is the duration of one OFDM symbol and is equal to N+C sample periods.

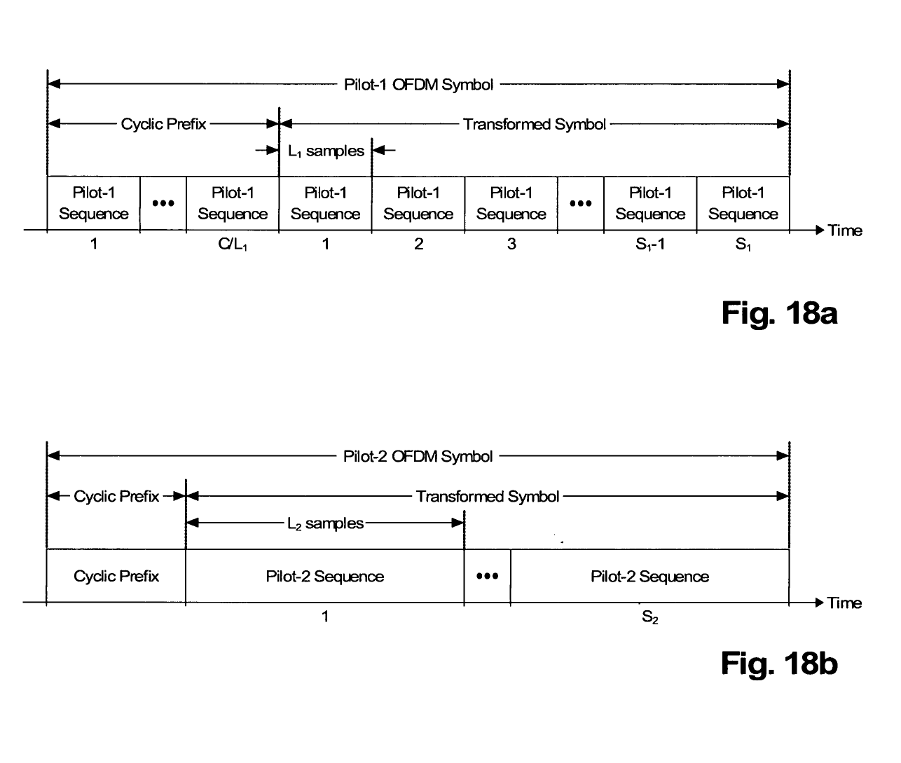

FIG. 18a shows a time-domain representation of TDM pilot-1. An OFDM symbol for TDM pilot-1 (or “pilot-1 OFDM symbol”) is composed of a transformed symbol of length N and a cyclic prefix of length C. Because the L₁ pilot symbols for TDM pilot 1 are sent on L₁ subbands that are evenly spaced apart by S₁ subbands, and because zero symbols are sent on the remaining subbands, the transformed symbol for TDM pilot 1 contains S₁ identical pilot-1 sequences, with each pilot-1 sequence containing L₁ time-domain samples. Each pilot-1 sequence may also be generated by performing an L₁-point IDFT on the L₁ pilot symbols for TDM pilot 1. The cyclic prefix for TDM pilot-1 is composed of the C rightmost samples of the transformed symbol and is inserted in front of the transformed symbol. The pilot-1 OFDM symbol thus contains a total of S₁+C/L₁pilot-1 sequences. For example, if N=4096, L₁=128 S₁=32, and C=512, then the pilot-1 OFDM symbol would contain 36 pilot-1 sequences, with each pilot-1 sequence containing 128 time-domain samples.

FIG. 18b shows a time-domain representation of TDM pilot-2. An OFDM symbol for TDM pilot-2 (or “pilot-2 OFDM symbol”) is also composed of a transformed symbol of length N and a cyclic prefix of length C. The transformed symbol for TDM pilot 2 contains S₂ identical pilot-2 sequences, with each pilot-2 sequence containing L₂ time-domain samples. The cyclic prefix for TDM pilot 2 is composed of the C rightmost samples of the transformed symbol and is inserted in front of the transformed symbol. For example, if N=4096, L₂=2048, S₂=2, and C=512, then the pilot-2 OFDM symbol would contain two complete pilot-2 sequences, with each pilot-2 sequence containing 2048 time-domain samples. The cyclic prefix for TDM pilot 2 would contain only a portion of the pilot-2 sequence.

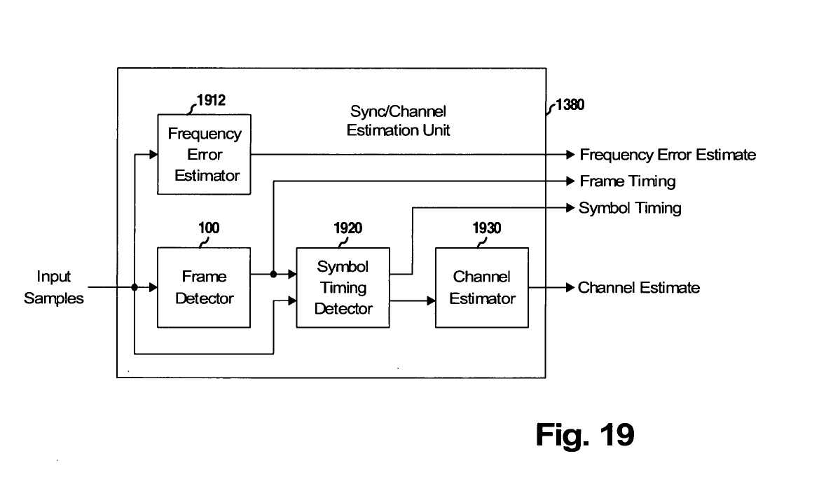

FIG. 19 shows a block diagram of an embodiment of synchronization and channel estimation unit 1380 at access terminal 3150. Within unit 1380, a frame detector 100 (as described in detail in supra) receives the input samples from receiver unit 1354, processes the input samples to detect for the start of each frame, and provides the frame timing. A symbol-timing detector 1920 receives the input samples and the frame timing, processes the input samples to detect for the start of the received OFDM symbols, and provides the symbol timing. A frequency-offset estimator 1912 estimates the frequency offset in the received OFDM symbols. A channel estimator 1930 receives an output from symbol timing detector 1920 and derives the channel estimate.

As described in further detail in FIG. 1, frame detector 100, performs frame synchronization by detecting for TDM pilot-1 in the input samples from receiver unit 1354. For simplicity, the instant detailed description assumes that the communication channel is an additive white Gaussian noise (AWGN) channel. The input sample for each sample period may be expressed as:
rₙ=xₙ+wₙ, (2)
Where n is an index for sample period;
xₙ is a time-domain sample sent by the access point in sample period n,
rₙ is an input sample obtained by the access terminal in sample period n, and
wₙ is the noise for sample period n.

Frequency offset estimator 1912 estimates the frequency offset in the received pilot-1 OFDM symbol. This frequency offset may be due to various sources such as, for example, a difference in the frequencies of the oscillators at the access point and access terminal, Doppler shift, and so on. Frequency offset estimator 1912 may generate a frequency offset estimate for each pilot-1 sequence (except for the last pilot-1 sequence), as follows:

$$Δ {f}_{l} = \frac{1}{{G}_{D}} Arg [ {\sum }_{i = 1}^{{L}_{1}} {r}_{l , i} \cdot {r}_{l , i + {L}_{1}}^{*} ] , \qquad ( 3 )$$

Where r_{l,i} is the i-th input sample for the l-th pilot-1 sequence;
Arg(x) is the arc-tangent of the ratio of the imaginary component of x over the real component of x, or Arg (x)=arc tan [Im(x)/Re(x)];
G_{D} is a detector gain, which is

$${G}_{D} = \frac{2 π \cdot {L}_{1}}{{f}_{samp}} ;$$

and
Δfₗ is the frequency offset estimate for the l-th pilot-1 sequence.
The range of detectable frequency offset may be given as:

$$2 π \cdot {L}_{1} \cdot \frac{\vert Δ {f}_{l} \vert}{{f}_{samp}} < π / 2 , or \vert Δ {f}_{l} \vert < \frac{{f}_{samp}}{4 \cdot {L}_{1}} , \qquad ( 4 )$$

Where fₛₐₘₚ is the input sample rate. Equation (4) indicates that the range of detected frequency offset is dependent on, and inversely related to, the length of the pilot-1 sequence. Frequency offset estimator 1912 may also be implemented within the frame detector component 100 and more specifically via the delayed correlator component 110 since the accumulated correlation results are also available from summer 524.

The frequency-offset estimates may be used in various manners. For example, the frequency-offset estimate for each pilot-1 sequence may be used to update a frequency-tracking loop that attempts to correct for any detected frequency offset at the access terminal. The frequency-tracking loop may be a phase-locked loop (PLL) that can adjust the frequency of a carrier signal used for frequency downconversion at the access terminal. The frequency-offset estimates may also be averaged to obtain a single frequency offset estimate Δf for the pilot-1 OFDM symbol. This Δf may then be used for frequency offset correction either prior to or after the N-point DFT within OFDM demodulator 160. For post-DFT frequency offset correction, which may be used to correct a frequency offset Δf that is an integer multiple of the subband spacing, the received symbols from the N-point DFT may be translated by Δf subbands, and a frequency-corrected symbol \tilde{R}ₖ for each applicable subband k may be obtained as \tilde{R}ₖ=\tilde{R}_{k+Δf}. For pre-DFT frequency offset correction, the input samples may be phase rotated by the frequency offset estimate Δf, and the N-point DFT may then be performed on the phase-rotated samples.

Frame detection and frequency-offset estimation may also be performed in other manners based on the pilot-1 OFDM symbol. For example, frame detection may be achieved by performing a direct correlation between the input samples for pilot-1 OFDM symbol with the actual pilot-1 sequence generated at the access point. The direct correlation provides a high correlation result for each strong signal instance (or multipath). Since more than one multipath or peak may be obtained for a given access point, an access terminal would perform post-processing on the detected peaks to obtain timing information. Frame detection may also be achieved with a combination of delayed correlation and direct correlation.

According to one embodiment, the carrier frequency and sampling clock frequency acquisition and/or tracking are achieved in a receiver through a single closed-loop compensator. In one embodiment, a first-order frequency locked-loop (FLL) is used, where other control schemes, such as linear, nonlinear, adaptive, expert- system, and neural network, of any order of complexity may also be used. The carrier frequency and/or sampling clock frequency may be derived from a voltage-controlled local oscillator (VCXO), e.g., in the receiver. Generally, such local oscillators are very sensitive to environmental factors, such as age, temperature, manufacturer, etc., and do not have a deterministic output (frequency) vs. input (voltage) characteristics. If the carrier frequency and/or sampling clock frequency are to be derived from a common VCXO, a single FLL directly controlling the VCXO may provide both carrier and sampling clock frequency acquisition and tracking.

In one embodiment, the cyclic prefix correlation is used to estimate the frequency offset, e.g., at each OFDM symbol, at each portion of an OFDM frame, or a combination thereof. If the transmitted signal x(t) has a periodic component, i.e., x[kTs]=x[(k+N)Ts], where Ts is the sampling period, k is time index, and N is periodicity, and the received signal is denoted by r(t), the phase of r*[k Ts]r[(k+N)Ts] provides a measure of the carrier frequency error associated with the transmitter and receiver, as discussed below.

Let the received signal with an initial phase offset φ and the frequency offset Δf be defined by:
r(t)=x(t)e^{j2πΔft+φ}+n(t) (5)
Where n(t) represents the noise signal. The sampled version of the received signal would be:
r(kTₛ)=x(kTₛ)e^{j2πΔfkT}^{ₛ}^{30 φ}+n(kTₛ) (6)
r*(kTₛ)r((k+N)Tₛ)=|x(kTₛ)|²e^{j2πΔfNT}^{ₛ}+noise (7)
The cyclic prefix in OFDM symbol defines the periodic structure of the waveform, making it suitable for estimating the frequency offset using the above algorithm.

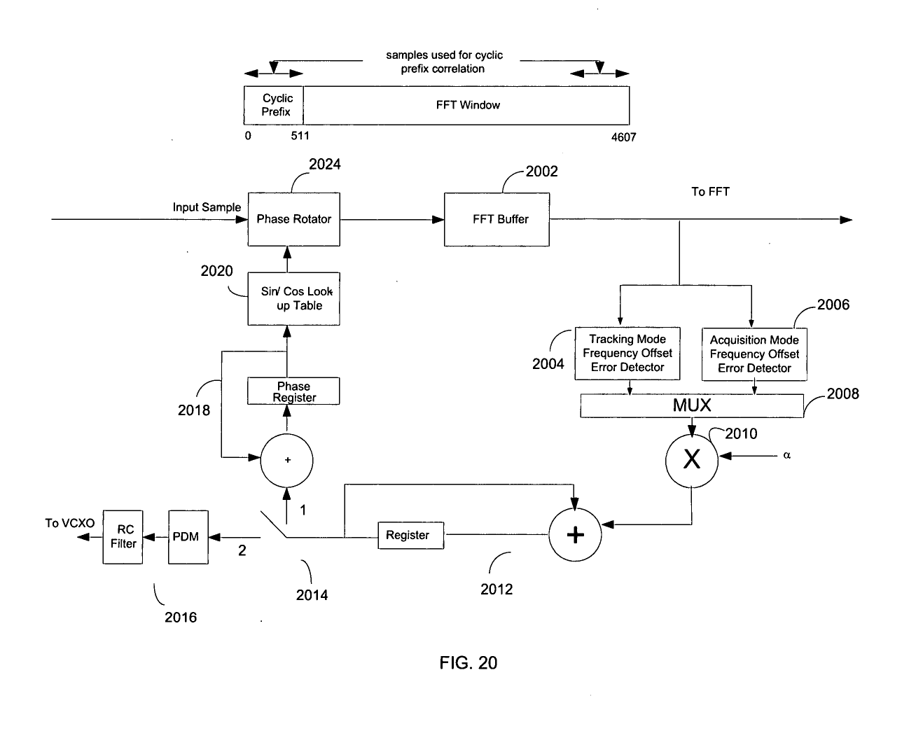

FIG. 20 illustrates a block diagram of a frequency locked-loop (FLL), according to one embodiment. Let {r_{m,k}} denote the received sample sequence of an (OFDM) symbol, where m denotes the (OFDM) symbol index and k denotes the sample time index, e.g., k=0, 1, 2, . . . , 4607. In one embodiment, as shown in the top portion of FIG. 20, the sample time indexes of k=0 to 511 represent the cyclic prefix part of the received OFDM symbol, and the FFT window starts at the sample time index of k=512 and ends at k=4607. For the frequency tracking mode of the FLL operation, the m^{th} estimate of the frequency offset may be obtained by:

$$Δ {\hat{f}}_{m} = \frac{1}{{G}_{D}} Im [ {\sum }_{k = 0}^{511} {r}_{m , k}^{*} {r}_{m , k + 4096} ] \qquad ( 8 )$$

Where G_{D} is the detector gain, as defined previously herein.

For the frequency acquisition mode of the FLL, the m^{th} estimate of the frequency offset may be obtained by either Equation (8) above or by Equation (4) given previously and repeated below, i.e.,

$$Δ {f}_{m} = \frac{1}{{G}_{D}} Arg [ {\sum }_{i = 0}^{127} {r}_{m , j} {r}_{m , i + 128}^{*} ] , \qquad ( 9 )$$

Where m is periodicity index of the duplicate sequences of samples in the first OFDM symbol, for example, 1 to 32 sequences, each of 128 samples. In one embodiment, the correlated input samples in Equation (8) and/or (9) belong to at least two sequences of input samples received during the first pilot symbol of the OFDM frame. The at least two sequences of input samples may be successive sequences of 128 samples each. The estimated frequency offset may be updated for a predetermined number of times, which may correspond to the number of duplicate sequences of samples in the first pilot symbol of the OFDM frame, e.g., about 32.

According to one embodiment, frequency offset given by either Equation (8) or (9) may be implemented by using a buffer 2002, e.g., of size 512 samples (tracking mode) or 128 samples (acquisition mode), a frequency offset detector 2004 (tracking mode) or 2006 (acquisition mode), and a 2-to-1 MUX 2008, which selects the output from one of the detectors 2004, 2006, as the case may be. The output of MUX 2008 may be scaled with a gain parameter, e.g., by a multiplier 2010, and then fed into a frequency-offset accumulator 2012. The frequency-offset accumulator 2012 generates an actual value of the frequency offset.

In one embodiment, the frequency-offset compensation may be carried out in at least two modes. In the simultaneous mode of operation of OFDMA with the CDMA, where the CDMA portion may digitally control the VCXO, the switch 2014 closes at position “1”, and the loop is closed. In the stand-alone mode, where the OFDMA portion may analytically control the VCXO, the switch 2014 opens to position “2” and the loop opens, so that the FLL directly controls the VCXO through the DAC 2016. In one embodiment, DAC 2016 may be a 1-bit DAC, including a pulse density modulator (PDM) and an RC filter. In this case, the actual value of the frequency offset, Δf is converted to a potential difference that is applied to the VCXO, so that the frequency offset is compensated.

In the CDMA-controlled case, the actual value of the frequency offset is fed, through switch 2014, to a phase accumulator 2018. The phase accumulator 2018 generates an actual value of the phase offset, φ. In one embodiment, sin/cos look up table 2020 generates the complex number “cos^{φ}−j sin^{φ}”, which defines exp(−j^{φ}), for rotating the phase of the input samples. The phase rotator, e.g., a complex multiplier, 2024 compensates the phase offset, or equivalently the frequency offset, of the input samples by multiplying the input samples with the complex number “cos^{φ}−j sin^{φ}”.

According to one embodiment, a gain of the frequency offset detector 2004, 2006, the VCXO gain, and/or the ratio of VCXO frequency to carrier frequency, etc., may be lumped together in a loop gain parameter a. The parameter a may also be quantized to a number which is a power of 2, and the multiplier 2010 may be replaced by a simple programmable shifter. It is noted that a may be different for the two modes of operations. According to one embodiment, a is applied to the FLL in increments until the frequency offset converges to a predetermined value, e.g., zero, in a predetermined time. The increments are chosen to be small enough, e.g., of 0.2, for maintaining the stability of the FLL, and large enough for the frequency error to quickly converge to the predetermined level in a predetermined time, e.g., during the first TDM pilot.

The disclosed embodiments may be applied to any one or combinations of the following technologies: Code Division Multiple Access (CDMA) systems, Multiple-Carrier CDMA (MC-CDMA), Wideband CDMA (W-CDMA), High-Speed Downlink Packet Access (HSDPA), Time Division Multiple Access (TDMA) systems, Frequency Division Multiple Access (FDMA) systems, and Orthogonal Frequency Division Multiple Access (OFDMA) systems.

The frequency acquisition and synchronization techniques described herein may be implemented by various means. For example, these techniques may be implemented in hardware, software, or a combination thereof. For a hardware implementation, the processing units at a access point used to support synchronization (e.g., TX data and pilot processor 120) may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. The processing units at an access terminal used to perform synchronization (e.g., synchronization and channel estimation unit 180) may also be implemented within one or more ASICs, DSPs, and so on.

For a software implementation, the synchronization techniques may be implemented in combination with program modules (e.g., routines, programs, components, procedures, functions, data structures, schemas . . . ) that perform the various functions described herein. The software codes may be stored in a memory unit (e.g., memory unit 1392 in FIG. 13) and executed by a processor (e.g., controller 190). The memory unit may be implemented within the processor or external to the processor.

Moreover, those skilled in the art will appreciate that the subject inventive methods may be practiced with other computer system configurations, including single-processor or multiprocessor computer systems, mini-computing devices, mainframe computers, as well as personal computers, hand-held computing devices, microprocessor-based or programmable consumer electronics, and the like.

What has been described above includes examples of some embodiments of the subject invention. It is, of course, not possible to describe every conceivable combination of components or methodologies for purposes of describing the disclosed embodiments, but one of ordinary skill in the art may recognize that many further combinations and permutations are possible. Accordingly, the disclosed embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A method for initial frequency acquisition in a wireless communication network, the method comprising:
receiving a stream of input samples;
determining an estimate for a frequency offset based on the received input samples; and
compensating for the frequency offset, thereby achieving an initial frequency acquisition.

2. The method of claim 1, wherein said receiving the stream of input samples comprises receiving input samples belonging to a first pilot symbol of a modulation frame, and wherein said determining an estimate for the frequency offset includes accumulating correlated input samples belonging to at least two sequences of input samples received during the first pilot symbol.

3. The method of claim 2, wherein at least two sequences of input samples are successive sequences of 128 samples each, and further comprising updating the frequency offset for a predetermined number of times.

4. The method of claim 3, wherein the predetermined number of times corresponds to the number of duplicate sequences of samples in the first pilot symbol of.

5. The method of claim 4, wherein the predetermined number of times is about 32.

6. The method of claim 1, wherein said compensating for the frequency offset comprises scaling the frequency offset by a gain parameter, wherein the gain parameter is chosen such that the frequency offset is compensated during a predetermined time period.

7. The method of claim 6, wherein the time period is duration of a first pilot symbol.

8. The method of claim 6, wherein said compensating for the frequency offset further comprises accumulating the scaled frequency offset, thereby obtaining an actual frequency offset.

9. The method of claim 8, wherein said compensating for the frequency offset further comprises controlling a local oscillator based on the actual frequency offset.

10. The method of claim 8, wherein said compensating for the frequency offset further comprises phase rotating the input samples.

11. The method of claim 10, wherein said phase rotating further comprises converting the actual frequency offset to a phase offset.

12. The method of claim 11, wherein said phase rotating further comprises phase rotating the input samples based on the phase offset.

13. A computer-readable medium embodying means for implementing a method for initial frequency acquisition in a wireless communication network, the method comprising:
receiving a stream of input samples;
determining an estimate for a frequency offset based on the received input samples; and
compensating for the frequency offset, thereby achieving an initial frequency acquisition.

14. An apparatus for initial frequency acquisition in a wireless communication network, comprising:
means for receiving a stream of input samples;
means for determining an estimate for a frequency offset based on the received input samples; and
means for compensating for the frequency offset, thereby achieving an initial frequency acquisition.

15. The apparatus of claim 14, wherein said means for receiving the stream of input samples comprises means for receiving input samples belonging to a first pilot symbol of a modulation frame, and wherein said means for determining an estimate for the frequency offset includes means for accumulating correlated input samples belonging to at least two sequences of input samples received during the first pilot symbol.

16. The apparatus of claim 15, wherein at least two sequences of input samples are successive sequences of 128 samples each, and further comprising means for updating the frequency offset for a predetermined number of times.

17. The apparatus of claim 16, wherein the predetermined number of times corresponds to the number of duplicate sequences of samples in the first pilot symbol.

18. The apparatus of claim 17, wherein the predetermined number of times is about 32.

19. The apparatus of claim 14, wherein said means for compensating for the frequency offset further comprises means for scaling the frequency offset by a gain parameter, wherein the gain parameter is chosen such that the frequency offset is compensated during a predetermined time period.

20. The apparatus of claim 19, wherein the time period is duration of a first pilot symbol.

21. The apparatus of claim 19, wherein said means for compensating for the frequency offset further comprises means for accumulating the scaled frequency offset, thereby obtaining an actual frequency offset.

22. The apparatus of claim 21, wherein said means for compensating for the frequency offset further comprises means for controlling a local oscillator based on the actual frequency offset.

23. The apparatus of claim 21, wherein said means for compensating for the frequency offset further comprises means for phase rotating the input samples.

24. The apparatus of claim 23, wherein said means for phase rotating further comprises means for converting the actual frequency offset to a phase offset.

25. The apparatus of claim 24, wherein said means for phase rotating further comprises means for phase rotating the input samples based on the phase offset.

26. An apparatus for initial frequency acquisition in a wireless communication network, comprising:
a receiver configured to receive a stream of input samples;
a processor configured to determine an estimate for a frequency offset based on the received input samples; and
a compensator configured to compensate for the frequency offset, thereby achieving an initial frequency acquisition.

27. The apparatus of claim 26, wherein the compensator comprises a multiplier configured to scale the frequency offset by a gain parameter.

28. The apparatus of claim 27, wherein the compensator further comprises an accumulator configured to generate an actual frequency offset.

29. The apparatus of claim 28, wherein the compensator further comprises a phase rotator.

30. At least one processor programmed to implement a method for initial frequency acquisition in a wireless communication network, the method comprising:
receiving a stream of input samples;
determining an estimate for a frequency offset based on the received input samples; and
compensating for the frequency offset, thereby achieving an initial frequency acquisition.
